(19) United States
(12) Patent Application Publication
(10) Pub. No.: US 2020/0207122 A1
(43) Pub. Date: Jul. 2, 2020

(54) LIQUID DISCHARGING DEVICE AND CONTROL DEVICE FOR LIQUID DISCHARGING DEVICE

(71) Applicant: SEIKO EPSON CORPORATION, Tokyo (JP)

(72) Inventor: Katsuya ASAMOTO, MATSUMOTO-SHI (JP)

(21) Appl. No.: 16/727,277

(22) Filed: Dec. 26, 2019

(30) Foreign Application Priority Data
Dec. 27, 2018 (JP) 2018-246042

(51) Int. Cl. B41J 11/00; B41J 3/407; B41J 2/045

(52) U.S. Cl. CPC B41J 11/002; B41J 2/04566; B41J 3/407

(57) ABSTRACT

The liquid discharging device includes a transporting unit disposed in a housing and configured to transport a medium placed outside the housing, a discharging unit configured to discharge liquid to the medium, a pre-heater configured to heat the medium and located upstream from a position where liquid is discharged by a discharging unit in a transport direction in which the medium is transported, an after-heater configured to heat the medium and located downstream, in the transport direction, from the position where the liquid is discharged, a detector configured to detect humidity outside the housing, and a control unit configured to control the pre-heater, wherein the medium is applied by a tension between a portion that contacts the transporting unit upstream from a position where the liquid is discharged in the transport direction, and a portion located downstream from the after-heater, and the control unit controls the pre-heater based on the humidity.

The present application is based on, and claims priority from JP Application Serial Number 2018-246042, filed Dec. 27, 2018, the disclosure of which is hereby incorporated by reference herein in its entirety.

### BACKGROUND

The present disclosure relates to a liquid discharging device and a control device for the liquid discharging discharge device.

JP-A-2017-121710 describes a liquid discharging device including a discharging unit configured to discharge liquid to a medium such as paper, and a transporting unit configured to transport the medium.

In such a liquid discharging device, a heater configured to heat a medium to which liquid is discharged may be included. When the medium to which the liquid is discharged is heated, the medium may shrink by drying.

### SUMMARY

Generally, the medium expands upon wetting and shrinks upon drying. When the liquid discharging device is disposed in a high humidity environment, the medium set in the liquid discharging device may wet. That is, when the liquid discharging device is disposed in the high humidity environment, in the medium, a portion expanded due to humidity and a portion shrunk due to the heater may occur. When tension is applied between the expanded portion and shrunk portion in the medium, wrinkles occur in the medium due to the difference in the degree of expansion between the expanded portion and shrunk portion. When wrinkles occur in the medium to a position at which the liquid is discharged by the discharging unit, the medium may contact the discharging unit. When the medium comes into contact with the discharging unit, the function of the discharging unit may be impaired.

A liquid discharging device according to one embodiment in the present disclosure includes: a housing, a transporting unit disposed inside the housing and configured to transport a medium placed outside the housing, a discharging unit configured to discharge liquid to the medium transported by the transporting unit, a pre-heater configured to heat the medium upstream, in a transport direction of the medium, from a position at which the liquid is discharged by the discharging unit, an after-heater configured to heat the medium downstream, in the transport direction, from a position at which the liquid is discharged by the discharging unit, a detector configured to detect humidity outside the housing, and a control unit configured to control the pre-heater, wherein the medium is applied with a tension between a portion that contacts with the transporting unit upstream, in the transport direction, from the position at which the liquid is discharged by the discharging unit, and a portion located downstream from the after-heater in the transport direction, and the control unit is configured to control the pre-heater based on the humidity detected by the detector.

In another embodiment, a control device for the liquid discharging device according to the present disclosure, can communicate with the liquid discharging device that includes: a housing, a transporting unit disposed inside the housing and configured to transport a medium placed outside the housing, a discharging unit configured to discharge liquid to the medium transported by the transporting unit, a pre-heater configured to heat the medium upstream, in a transport direction of the medium, from a position at which the liquid is discharged by the discharging unit, an after-heater configured to heat the medium downstream, in the transport direction, from a position at which the liquid is discharged by the discharging unit, a detector configured to detect humidity outside the housing and a control unit configured to control the pre-heater. And, the control device is configured to observe a state variable including the humidity detected by the detector, acquire medium floating data related to an occurrence of medium floating, learn a condition associated with medium floating of the medium according to a training data set created based on the combination of the state variable and the medium floating data, and cause the control unit to perform control of the pre-heater based on the condition.

### BRIEF DESCRIPTION OF THE DRAWINGS

FIG. 1 is a side view schematically illustrating an exemplary embodiment of a liquid discharging device.

FIG. 2 is a block diagram of a control unit.

FIG. 3 is a block diagram of a control device configured to control a liquid discharging device.

FIG. 4 is a side view illustrating a modified example of the liquid discharging device.

### DESCRIPTION OF EXEMPLARY EMBODIMENTS

One exemplary embodiment of the liquid discharging device will be described below with reference to drawings. The liquid discharging device is, for example, an ink jet-type printer that records an image such as characters and photographs on a medium such as a sheet by discharging ink which is an example of the liquid.

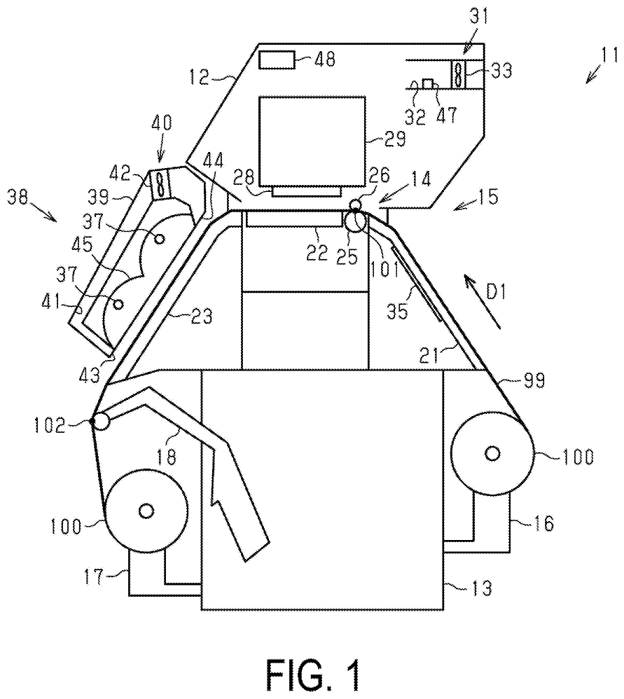

As illustrated in FIG. 1, the liquid discharging device 11 includes a housing 12. The liquid discharging device 11 includes a base 13 that supports the housing 12. In the present embodiment, the housing 12 is positioned above the base 13.

The liquid discharging device 11 includes a transporting unit 14 configured to transport medium 99. The transporting unit 14 is disposed in the housing 12. The transporting unit 14 transports the medium 99 placed outside the housing 12 along a transport path 15. In the present embodiment, a transport direction D1 is a direction in which the medium 99 placed outside the housing 12 is transported by the transporting unit 14.

The liquid discharging device 11 includes a placing unit 16 on which a roll body 100 on which the medium 99 is wound can be placed. The placing unit 16 is attached to the base 13, for example. The placing unit 16 supports the roll body 100 on which the medium 99 is wound before the liquid is discharged in a rotatable state. When the transporting unit 14 is driven, the medium 99 is fed out from the roll body 100.

Note that in the present embodiment, the liquid discharging device 11 is configured to include the placing unit 16, but the liquid discharging device 11 may be configured so as to discharge the liquid to the medium 99 that is fed out from the roll body 100 placed on the disposing surface on which the liquid discharging device 11 is disposed. Additionally, the liquid discharging device 11 may be configured so as to discharge the liquid to the medium 99 that is fed out from a device different from the liquid discharging device 11. Furthermore, the liquid discharging device 11 is not limited to the configuration in which the liquid is discharged to the medium 99 that is fed out from the roll body 100. For example, the liquid discharging device 11 may be configured to discharge liquid to an elongated medium 99 such as fan-fold paper.

The liquid discharging device 11 may include a winding unit 17 configured to wind the recorded medium 99. The winding unit 17 is attached to the base 13, for example. The winding unit 17 winds the medium 99 discharged with the liquid as the roll body 100. The liquid discharging device 11 may be configured so as to transport the medium 99, to which liquid is discharged, to a device different from the liquid discharging device 11. The liquid discharging device 11 may be configured so as to wind the medium 99, to which the liquid is discharged, onto a device different from the liquid discharging device 11.

The liquid discharging device 11 includes a tension bar 18 that applies tension to the medium 99 as a tension applying unit. The tension bar 18 applies tension to the medium 99 by contacting with the medium 99. By applying tension to the medium 99 by the tension bar 18, the liquid can be precisely landed on the medium 99. Note that in the present embodiment, the liquid discharging device 11 is configured to include the tension bar 18 as the tension applying unit, but also a roller pair that sandwiched the medium 99, such as the winding unit 17 and the transporting unit 14, may act as the tension applying unit. In this case, a feed amount of the medium 99 by the winding unit 17 and the roller pair is controlled, and thus the tension is applied to the medium 99.

The tension bar 18 is attached to the base 13, for example. The tension bar 18 is removably attached to the base 13. The length of the medium 99 between the winding unit 17 and the transporting unit 14 varies due to the difference between the feed amount of the medium 99 in the winding unit 17 and the feed amount of the medium in the transporting unit 14 described below. The tension bar 18 is displaced depending on the length of the medium 99 between the winding unit 17 and the transporting unit 14. The tension applied to the medium 99 is adjusted by the displacement of the tension bar 18 in this manner. Note that in the present embodiment, the tension bar 18 is displaceable with respect to the base 13, but the tension bar 18 may not be displaceable with respect to the base 13. In this case, tension is applied to the medium 99 by the winding unit 17 and the roller pair acting as the tension applying section described above and the tension bar 18.

The liquid discharging device 11 of the present embodiment includes a first supporting unit 21, a second supporting unit 22, and a third supporting unit 23 that constitute the transport path 15. The first supporting unit 21, the second supporting unit 22, and the third supporting unit 23 support the medium 99 transported by the transporting unit 14. The first supporting unit 21, the second supporting unit 22, and the third supporting unit 23 are placed in an order from upstream to downstream in the transport direction D1. That is, the first supporting unit 21 configures an upstream portion in the transport direction D1 of the transport path 15, the second supporting unit 22 configures a midstream portion in the transport direction D1 of the transport path 15, and the third supporting unit 23 configures a downstream portion in the transport direction D1 of the transport path 15. The second supporting unit 22 is located inside the housing 12.

The transporting unit 14 of the present embodiment includes a first roller 25 and a second roller 26. The first roller 25 and the second roller 26 transport the medium 99 by rotating in a state of sandwiching the medium 99. The first roller 25 and the second roller 26 are positioned so as to sandwich the medium 99 between the first supporting unit 21 and the second supporting unit 22 in the transport direction D1.

The liquid discharging device 11 includes a discharging unit 28 configured to discharge liquid to the medium 99 transported to the transporting unit 14. The discharging unit 28 of the present embodiment is positioned at a position facing the second supporting unit 22. Thus, the discharging unit 28 discharges the liquid to the portion of the medium 99 supported by the second supporting unit 22.

The liquid discharging device 11 of the present embodiment includes a carriage 29 on which a discharging unit 28 is placed. The carriage 29 scans with respect to the medium 99 that is transported. In other words, the liquid discharging device 11 of the present embodiment is a serial printer in which the discharging unit 28 scans with respect to the medium 99. The liquid discharging device 11 may be a line printer in which the discharging unit 28 is disposed in an elongated shape.

The liquid discharging device 11 of the present embodiment includes an intake mechanism 31 that takes in the air outside the housing 12 into the housing 12. The intake mechanism 31 includes an intake path 32 and a fan 33, for example. The fan 33 is located in the intake path 32. The air outside the housing 12 is taken into the housing 12 through the intake path 32, by be driven by the fan 33. The housing 12 is ventilated by the intake mechanism 31.

The liquid discharging device 11 includes a pre-heater 35 that heats the medium 99. The pre-heater 35 is positioned upstream from the position at which the liquid is discharged by the discharging unit 28 in the transport direction D1. In addition, the pre-heater 35 heats the medium 99 upstream from the position at which the liquid is discharged by the discharging unit 28 in the transport direction D1. Thus, the pre-heater 35 heats the portion of the medium 99 before the liquid is discharged.

The pre-heater 35 of the present embodiment is a sheet-shaped heater. The pre-heater 35 is attached to a back surface opposite to a surface of the first supporting unit 21 that contacts with the medium 99. The heat of the pre-heater 35 is transferred to the medium 99 via the first supporting unit 21. As a result, the portion of the medium 99 before the liquid is discharged is dried.

In the present embodiment, the region of the mecium 99 that is heated by the pre-heater 35 in the transport direction D1 is located outside the housing 12. For example, the pre-heater 35 is attached to a portion located outside the housing 12 in the first supporting unit 21. In this configuration, the heat of the pre-heater 35 is difficult to reach inside the housing 12. Thereby, the temperature inside the housing 12 can be suppressed from becoming high. For example, it is possible to reduce the risk that the liquid in the discharging unit 28 is solidified or denatured due to the heat. Note that in the present embodiment, the pre-heater 35 is a sheet-shaped heater attached to the back surface of the first supporting unit 21, and thus, a region of the medium 99 heated by the pre-heater 35 in the transport direction D1 may be positioned outside the housing 12 so as to make a region where the heat conductivity of the first supporting unit 21 is high to be outside the housing 12.

The liquid discharging device 11 includes an after-heater 37 for heating the medium 99. The after-heater 37 is positioned downstream from the position where the liquid is discharged by the discharging unit 28 in the transport direction D1. Further, the after-heater 37 heats the medium 99 downstream from the position at which the liquid is discharged by the discharging unit 28 in the transport direction D1. Thus, the after-heater 37 heats the portion of the medium 99 after the liquid is discharged.

The after-heater 37 of the present embodiment is a heater tube. The after-heater 37 is positioned so as to face the surface of the third supporting unit 23, which is a surface that contacts with the medium 99, in the third supporting unit 23. The after-heater 37 heats a portion of the medium 99 supported by the third supporting unit 23. As a result, the portion of the medium 99 after the liquid is discharged is dried. The after-heater 37 is controlled so as to properly dry the portion of the medium 99 after the liquid is discharged. For example, the after-heater 37 is controlled based on the amount of liquid discharged to the medium 99. In this case, the greater the amount of liquid discharged to the medium 99, the greater the output of the after-heater 37.

The liquid discharging device 11 of the present embodiment includes a drying mechanism 38 having an after-heater 37. The drying mechanism 38 includes a case 39 that accommodates the after-heater 37, and a circulation unit 40 that circulates gas in the case 39. The case 39 is positioned so as to face the third supporting unit 23.

The circulation unit 40 includes a circulation path 41 through which gas flows, and a fan 42 positioned in the circulation path 41. The circulation path 41 is a flow path connecting an intake port 43 that takes in the gas and a blower port 44 that sends out the gas. The circulation path 41 extends around the after-heater 37. The intake port 43 is positioned so as to face the downstream portion of the third supporting unit 23 in the transport direction D1. The blower port 44 is positioned so as to face the upstream portion of the third supporting unit 23 in the transport direction D1. The circulation unit 40 circulates the gas heated by the after-heater 37 within the case 39. Thus, drying of the medium 99 is promoted.

The drying mechanism 38 may have a reflector 45 that reflects the heat of the after-heater 37 toward the third supporting unit 23. This allows the heat of the after-heater 37 to be efficiently transferred to the medium 99.

The liquid discharging device 11 includes a detector 47 that detects humidity outside the housing 12. In other words, the detector 47 detects the humidity of the environment in which the liquid discharging device 11 is disposed. The detector 47 detects the relative humidity of the outside air. The detector 47 of the present embodiment is positioned in the intake path 32. In this way, humidity outside the housing 12 taken in by the fan 33 can be efficiently detected. The detector 47 may be disposed in a position that can detect the humidity of the outside air, for example, the detector 47 may be attached to the base 13.

The detector 47 may be configured to detect a temperature outside the housing 12. For example, the detector 47 may be configured by a temperature and humidity sensor. By detecting the temperature and humidity by the detector 47, the absolute humidity of the environment in which the liquid discharging device 11 is disposed can be identified. Note that in the present embodiment, the absolute humidity is identified by the temperature detected by the detector 47 and the relative humidity, but a detector that can detect the absolute humidity of the outside air may be disposed as the detector 47.

The liquid discharging device 11 includes a control unit 48 configured to acquire the humidity detected by the detector 47. The control unit 48 of the present embodiment comprehensively controls the liquid discharging device 11. The control unit 48 is configured by CPU, memory, and the like, for example. The control unit 48 controls the liquid discharging device 11 by executing a program stored in the memory by the CPU. When the detector 47 detects humidity and temperature outside the housing 12, the control unit 48 acquires the temperature and humidity detected by the detector 47.

In the liquid discharging device 11, the medium 99 is applied with a tension between a portion that contacts the transporting unit 14 upstream from a position where the liquid is discharged by the discharging unit 28 in the transport direction D1, and a portion located downstream from the position in the transport direction D1 that is heated by the after-heater 37. In the present embodiment, the medium 99 is applied with the tension between two points between a portion sandwiched by the first roller 25 and the second roller 26 and a portion in contact with the tension bar 18. Specifically, the medium 99 is restrained by the first roller 25 and the second roller 26 sandwiching the medium 99, and the tension bar 18 is brought into contact with the medium 99 so as to press the medium 99, thus the tension is applied to the medium 99.

In order to apply the tension to the medium 99, the portion of the medium 99 that contacts with the transporting unit 14 is referred to as a first portion 101. In order to apply the tension to the medium 99, a portion of the medium 99 in contact with the configuration that applies the tension is referred to as a second portion 102. In the present embodiment, the portion of the medium 99 that contacts the tension bar 18 is the second portion 102. The tension bar 18 contacts the medium 99 with such a force that the second portion 102 does not slip relative to the first roller 25 and the second roller 26. When the liquid discharging device 11 does not include the tension bar 18 and the medium 99 discharged with the liquid is transported to another device different from the liquid discharging device 11, the configuration of the another device can be configured to apply the tension to the medium 99.

The medium 99 discharged with the liquid by the discharging unit 28 is heated by the after-heater 37. The medium 99 is dried by the heating of the after-heater 37. The medium 99 shrinks upon drying. As a result, the second portion 102 of the medium 99 that contacts tension bar 18 is a shrunk portion.

The medium 99 is influenced by the environment in which the liquid discharging device 11 is disposed. When the humidity of the environment in which the liquid discharging device 11 is disposed is high, the medium 99 placed outside the housing 12 is wetted. The portion of the medium 99 before the liquid is discharged is placed outside the housing 12, thus it is easily influenced by humidity. The medium 99 expands upon wetting. Therefore, when the humidity of the environment is high, the roll body 100 placed on the placing unit 16 is expanded by wetting.

When the first portion 101 of the medium 99 that contacts with the first roller 25 and the second roller 26 becomes into a portion that is expanded by humidity, a difference in the degree of stretching occurs between the first portion 101 and the second portion 102. When the difference in the degree of stretching of the medium 99 is large, wrinkles may be occurred in the medium 99. In particular, the difference in the degree of stretching of the medium 99 in the width direction tends to be a factor of wrinkles. Specifically, the width of the wetted portion in the medium 99 becomes longer and the width of the dried portion in the medium 99 becomes shorter.

When tension is applied to the medium 99 between two points of the expanded first portion 101 and the shrunk second portion 102, wrinkles may occur in the medium 99 from the first portion 101 to the second portion 102. At this time, when wrinkles are occurred in the medium 99 to a position where the liquid is discharged by the discharging unit 28, the medium 99 may come into contact with the discharging unit 28. More specifically, when wrinkles occur on the medium 99, the medium 99 floats from the state where the medium is supported. As described above, when wrinkles are occurred on the medium 99 at a position where the liquid is discharged by the discharging unit 28, the medium 99 floats from the second supporting unit 22. As a result, the medium 99 may come into contact with the discharging unit 28. When the medium 99 comes into contact with the discharging unit 28, the discharging unit 28 can not normally discharge the liquid, and there is a risk of impairing the function of the discharging unit 28. In addition, when the medium 99 contacts the discharging unit 28, undesired liquid may adhere to the medium 99.

The liquid discharging device 11 heats the medium 99 placed outside the housing 12 by a pre-heater 35. The medium 99 is dried by heating the preheater 35. As a result, the first portion 101 shrinks. In this case, tension is applied between the shrunk first portion 101 and the shrunk second portion 102. When the first portion 101 shrinks, the difference in the degree of stretching becomes smaller between the first portion 101 and the second portion 102 compared to the case where the first portion 101 expands, and thus wrinkles are difficult to occur on the medium 99.

When the medium 99 is dried too much by the pre-heater 35, the medium 99 may shrink further. In this case, wrinkles are more likely to occur in the medium 99 due to the difference in the degree of stretching between the further shrunk first portion 101 and the shrunk second portion 102. When the first portion 101 is excessively dried by the pre-heater 35, the difference in the degree of stretching of the medium 99 increases compared to a case where the first portion 101 is appropriately dried by the pre-heater 35, and thus wrinkles are likely to occur on the medium 99. In addition, when the medium 99 is excessively dried by the pre-heater 35, the medium 99 also leads to damage.

The control unit 48 controls the pre-heater 35 based on the humidity detected by the detector 47. By controlling the pre-heater 35 based on humidity, the portion before the liquid is discharged of the medium 99 can be appropriately dried. In this way, the difference in the degree of stretching of the medium 99 is reduced, and thus wrinkles are difficult to occur on the medium 99. The control unit 48 of the present embodiment controls the pre-heater 35 so that the difference in the degree of stretching becomes small between the first portion 101 and the second portion 102. As a result, the difference in the degree of stretching of the first portion 101 and the second portion 102 is reduced, as a result, the possibility of wrinkles occurring in the medium 99 can be reduced.

The control unit 48 of the present embodiment increases the output of the pre-heater 35 when the humidity detected by the detector 47 is a second humidity, larger than the output of the pre-heater 35 when the humidity detected by the detector 47 is a first humidity, wherein the second humidity is higher than the first humidity. The higher the humidity of the environment, the greater the amount of water contained in the wetting medium 99. Thus, the medium 99 can be appropriately dried by increasing the output of the pre-heater 35 when the humidity of the environment is in the second humidity, larger than the output of the pre-heater 35 when the environment is in the first humidity, wherein the second humidity is higher than the first humidity. For example, the higher the humidity detected by the detector 47, the higher the temperature at which the pre-heater 35 heats the medium 99 increases.

The control unit 48 may control the pre-heater 35 based on the temperature and humidity detected by the detector 47. The amount of water contained in the wetting media 99 varies with absolute humidity. Relative humidity, on the other hand, varies with temperature. The control unit 48 can identify the absolute humidity from the temperature and humidity detected by the detector 47. By controlling the pre-heater 35 based on absolute humidity, the medium 99 may be more appropriately dried. For example, the control unit 48 controls such that the temperature at which the pre-heater 35 heats the medium 99 increases as the absolute humidity of the environment increases. The same applies to a case where the detector 47 directly detects absolute humidity. In this case, the control unit 48 increases the output of the pre-heater 35 when the absolute humidity detected by the detector 47 is a second humidity larger than the output of the pre-heater 35 when the absolute humidity detected by the detector 47 is the first humidity, wherein the second humidity is higher than the first humidity.

The pre-heater 35 may be controlled by machine learning unit that performs machine learning. In this case, the control unit 48 included in the liquid discharging device 11 may function as a machine learning unit. For example, the control unit 48 may observe a state variable including the humidity outside the housing 12, acquire medium floating data related to an occurrence of medium floating, learn a condition associated with the medium floating of the medium according to a training data set that is created based on the combination of the state variable and the medium floating data, and control the pre-heater 35 based on the condition. In this way, the pre-heater 35 can be controlled with greater accuracy, thus the medium 99 can be appropriately dried.

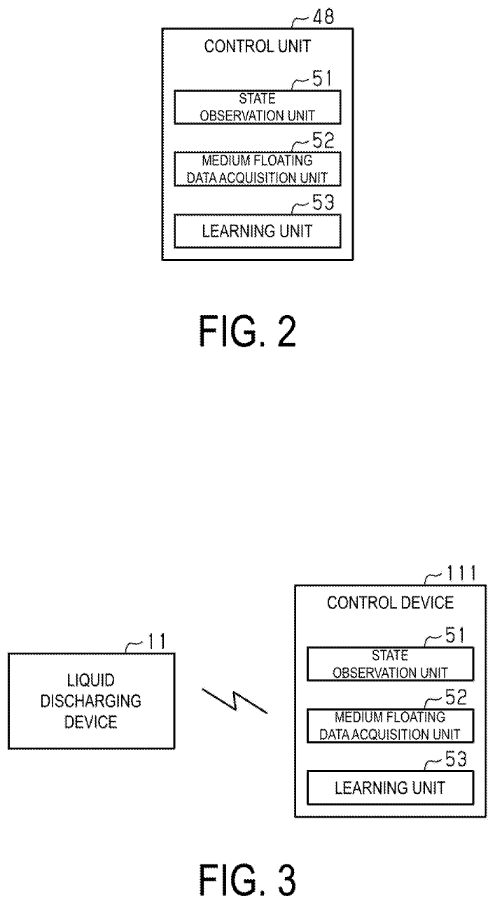

As illustrated in FIG. 2, the control unit 48 functioning as a machine learning unit includes a state observation unit 51, medium floating data acquisition unit 52, and a learning unit 53. The state observation unit 51 observes a state variable including humidity outside the housing 12. The state observation unit 51 of the present embodiment observes humidity outside the housing 12 detected by the detector 47. The state variable may include temperatures outside housing 12 besides humidity outside housing 12. In addition, the state variable may include an amount of liquid to be discharged by the discharging unit 28 to the medium 99, a transport speed of the medium 99 by the transporting unit 14, a type of the medium 99, and the like. The state observation unit 51 observes such a state variable.

The medium floating data acquisition unit 52 acquires medium floating data for the occurrence of medium floating of the floating medium 99 due to occurrence of wrinkles. The medium floating data is data acquired by the medium 99 coming into contact with the discharging unit 28 when the medium 99 is transported. When the medium 99 contacts the discharging unit 28, the user may input the medium floating data to the medium floating data acquisition unit 52. It may be configured such that, a sensor detecting that the medium 99 is in contact with the discharging unit 28, is disposed, and the medium floating data detected by the sensor are input to the medium floating data acquisition unit 52.

The learning unit 53 learns the condition associated with medium floating of the medium 99 according to the training data set created based on a combination of the state variable observed by the state observation unit 51 and the medium floating data acquired by the medium floating data acquisition unit 52. Any learning algorithm used by the learning unit 53 may be used. Learning algorithms include, for example, supervised learning, unsupervised learning, and reinforcement learning.

As illustrated in FIG. 3, a control device 111 that can communicate with the liquid discharging device 11 may function as a machine learning unit. The control device 111 can control the liquid discharging device 11 by being connected to the liquid discharging device 11. The control device 111 is a computer, for example, and includes CPU, memory, and the like. The control device 111 includes a state observation unit 51, medium floating data acquisition unit 52, and a learning unit 53.

The control device 111 is configured to observe a state variable including a humidity outside the housing 12, acquire medium floating data that related to the occurrence of medium floating, learn a condition associated with the medium floating of the medium 99 according to a training data set that is created based on the combination of the state variable and the medium floating data, and cause the control unit 48 of the liquid discharging device 11 to perform control of the pre-heater 35 based on the condition. In this way, the pre-heater 35 can be controlled with high accuracy, and the medium 99 can be appropriately dried.

The action and the effect of the exemplary embodiment will now be described.

When the humidity of the environment in which the liquid discharging device 11 is disposed is high, the medium 99 placed outside the housing 12 is wetted. Generally, in the medium 99, the wetted portion expands and the dried portion shrinks. The medium 99 is applied with a tension between a portion that contacts the transporting unit 14 upstream from a position where the liquid is discharged by the discharging unit 28 in the transport direction D1, and a portion located downstream from the after-heater 37 in the transport direction D1. In this case, the portion expanded by humidity is in contact with the transporting unit 14. That is, tension is applied to the medium 99 between the portion expanded by humidity and the portion that is shrunk by the after-heater 37. When the portion expanded by humidity is in contact with the transporting unit 14, the difference in the degree of stretching of the medium 99 increases, and thus wrinkles are more likely to occur in the medium 99.

The pre-heater 35 dries the medium 99 wetted by humidity. In this case, the portion shrunk by the pre-heater 35 contacts the transporting unit 14. In other words, the tension is applied to the medium 99 between the portion shrunk by the pre-heater 35 and the portion shrunk by the after-heater 37. When the portion shrunk by the pre-heater 35 contacts the transporting unit 14, the difference in the degree of stretching of the medium 99 becomes smaller compared to a case where the portion expanded by humidity is in contact with the transporting unit 14, and thus wrinkles are difficult to occur in the medium 99.

When the medium 99 is dried too much by the pre-heater 35, the medium 99 may shrink further. In this case, the portion that is further shrunk by the pre-heater 35 contacts the transporting unit 14. That is, the tension is applied between the portion that is further shrunk by the pre-heater 35 and the portion shrunk by the after-heater 37. When the portion that is further shrunk by the pre-heater 35 contacts the transporting unit 14, the difference in the degree of stretching of the medium 99 increases as compared with a case where the medium 99 is appropriately dried by the pre-heater 35, and thus wrinkles are likely to occur in the medium 99.

The control unit 48 controls the pre-heater 35 based on the humidity detected by the detector 47. By controlling the pre-heater 35 based on humidity, the medium 99 can be appropriately dried. In this way, the difference in the degree of stretching of the medium 99 is reduced, and thus wrinkles are difficult to occur. Thus, the possibility of wrinkles occurring in the medium 99 can be reduced.

The control unit 48 increases the output of the pre-heater 35 when the humidity is a second humidity larger than the output of the pre-heater 35 when the humidity is a first humidity, wherein the second humidity is higher than the first humidity. The higher the humidity, the greater the amount of water contained in the wetting medium 99. Thus, the medium 99 can be appropriately dried by increasing the output of the pre-heater 35 when the humidity is in a second humidity larger than the output of the pre-heater 35 when the humidity is a first humidity, wherein the second humidity is higher than the first humidity.

The control unit 48 controls the pre-heater 35 based on the relative humidity and temperature. The amount of water contained in the medium 99 wetted by humidity varies with absolute humidity. Absolute humidity can be identified from the relative temperature and humidity detected by the detector 47. By controlling the pre-heater 35 based on absolute humidity, the medium 99 wetted by humidity can be more appropriately dried.

The control unit 48 controls the pre-heater 35 based on absolute humidity. The amount of water contained in the medium 99 wetted by humidity varies with absolute humidity. By controlling the pre-heater 35 based on the absolute temperature detected by the detector 47, the medium 99 that is wetted by humidity can be more appropriately dried.

The region of the medium 99 that is heated by the pre-heater 35 in the transport direction D1 is located outside the housing 12. A pre-heater 35 heats the medium 99 outside the housing 12. Thus, the heat of the pre-heater 35 is difficult to reach inside the housing 12. Thereby, the temperature inside the housing 12 can be suppressed from becoming high.

The control unit 48 learns the condition related to the medium floating of the medium 99 according to a training data set created based on a combination of the state variable and the medium floating data, and controls the pre-heater 35 based on the condition. This allows the medium 99 that is wetted by humidity to be appropriately dried.

The control device 111, which can communicate with the liquid discharging device 11, learns the condition related to the medium floating of the medium 99 according to a training data set created based on a combination of the state variable and the medium floating data, and performs the control that is for the pre-heater 35 and based on that condition by the control unit 48. This allows the medium 99 that is wetted by humidity to be appropriately dried.

The exemplary embodiment described above may be modified as follows. The exemplary embodiment and the modified examples below may be implemented in combination within a range in which a technical contradiction does not arise.

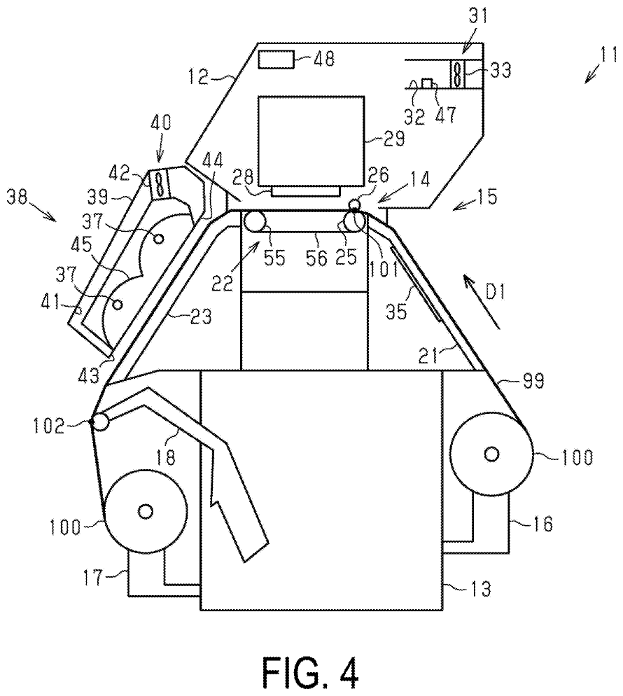

As illustrated in FIG. 4, the transporting unit 14 may include a belt mechanism. In this modified example, the transporting unit 14 also serves as the second supporting unit 22. The transporting unit 14 in this modified example includes a first roller 25, a second roller 26, a third roller 55, and a belt 56. The third roller 55 is positioned upstream of the third supporting unit 23 in the transport direction D1.

The belt 56 is wound on the first roller 25 and the third roller 55. The belt 56 rotates the first roller 25 and the third roller 55 by rotating the first roller 25. The second roller 26 presses the medium 99 against the belt 56. As a result, the suction force of the belt 56 with respect to the medium 99 is ensured. The medium 99 is transported by that the belt 56 sucking the medium 99 rotates. In this modified example, a portion of the medium 99 sandwiched between the first roller 25 and the second roller 26 via the belt 56 becomes the first portion 101.

When the humidity outside the housing 12 is equal to or lower than the predetermined humidity, the control unit 48 may control the pre-heater 35 so as not to be driven. When the humidity of the environment is low, the possibility that the medium 99 is excessively dried can be reduced by not heating the medium 99 by the pre-heater 35.

The pre-heater 35 may be a heater tube, such as an after-heater 37. In this case, the pre-heater 35 is positioned at a position facing the first supporting unit 21. In addition, in this case, the configuration in which the region of the medium 99 that is heated by the pre-heater 35 in the transport direction D1 is positioned outside the housing 12 is a configuration in which a heater tube as the pre-heater 35 is disposed outside the housing 12.

The after-heater 37 may be a sheet-shaped heating element such as the pre-heater 35. In this case, the after-heater 37 is attached to the back surface of the third supporting unit 23.

The medium 99 is not limited to long paper fed out from the roll body 100, but may be a single sheet paper. The medium 99 is not limited to paper, but may be a fabric.

The liquid discharged by the discharging unit 28 is not limited to ink, and may be, for example, a liquid material including particles of a functional material dispersed or mixed in liquid. For example, the discharging unit 28 may discharge a liquid material including a material such as an electrode material or a pixel material used in manufacture of liquid crystal display, an electroluminescent display, and a surface emitting display in a dispersed or dissolved form.

Technical ideas understood from the embodiments and modifications described above and operational effects thereof will be described below.

A liquid discharging device described above includes: a housing, a transporting unit disposed inside the housing and configured to transport a medium placed outside the housing, a discharging unit configured to discharge liquid to the medium transported by the transporting unit, a pre-heater configured to heat the medium upstream, in a transport direction of the medium, from a position at which the liquid is discharged by the discharging unit, an after-heater configured to heat the medium downstream from a position at which the liquid is discharged by the discharging unit in the transport direction, a detector configured to detect humidity outside the housing, and a control unit configured to control the pre-heater, wherein the medium is applied with a tension between a portion that contacts with the transporting unit upstream from the position at which the liquid is discharged by the discharging unit in the transport direction, and a portion located downstream of the after-heater in the transport direction, and the control unit is configured to control the pre-heater based on the humidity detected by the detector.

When the humidity of the environment in which the liquid discharging device is disposed is high, the medium placed outside the housing is wetted. Generally, in media, the wetted portion expands and the dried portion shrinks. The medium is applied with the tension between a portion that contacts the transporting unit upstream of a position at which the liquid is discharged by the discharging unit in the transport direction, and a portion located downstream of the after-heater in the transport direction. In this case, the portion expanded by humidity is in contact with the transporting unit. That is, tension is applied to the medium between the portion expanded by humidity and the portion shrunk by the after-heater. When the portion expanded by humidity is in contact with the transporting unit, the difference in the degree of stretching of the medium increases, and thus wrinkles are likely to occur on the medium.

The pre-heater dries the medium wetted by the humidity. In this case, the portion shrunk by the pre-heater contacts the transporting unit. That is, tension is applied to the medium between the portion shrunk by the pre-heater and the portion shrunk by the after-heater. When the portion shrunk by the pre-heater contacts the transporting unit, the difference in the degree of stretching of the medium becomes smaller compared to a case where the portion expanded by humidity is in contact with the transporting unit, and thus wrinkles are difficult to occur on the medium.

If the medium is dried too much by the pre-heater, the medium may shrink further. In this case, the portion that is further shrunk by the pre-heater contacts the transporting unit. That is, the tension is applied between the portion that is further shrunk by the pre-heater and the portion shrunk by the after-heater. When the portion that is further shrunk by the pre-heater contacts the transporting unit, the difference in the degree of stretching of the medium increases compared to a case where the medium is appropriately dried by the pre-heater, and thus wrinkles are likely to occur on the medium.

According to the above-described configuration, the medium can be appropriately dried by controlling the pre-heater based on the humidity detected by the detector. In this way, the difference in the degree of stretching of the medium becomes small, and thus wrinkles are difficult to occur. Thus, the possibility of wrinkles occurring on the medium can be reduced.

In the liquid discharging device, the control unit may increase the output of the pre-heater when the humidity is a second humidity larger than the output of the pre-heater when the humidity is a first humidity, wherein the second humidity is higher than the first humidity.

The higher the humidity, the greater the amount of water contained in the wetting medium. Thus, the medium can be appropriately dried by increasing the output of the pre-heater when the humidity is the second humidity larger than the output of the pre-heater when the humidity is the first humidity, wherein the second humidity is higher than the first humidity.

In the liquid discharging device, the detector may detect a temperature outside the housing, the humidity detected by the detector is a relative humidity, and the control unit may control the pre-heater based on the temperature and the relative humidity detected by the detector.

The amount of water contained in the medium wetted by humidity varies with absolute humidity. Absolute humidity can be identified from the temperature and humidity detected by the detector. By controlling the pre-heater based on absolute humidity, the medium wetted by humidity can be more appropriately dried.

In the liquid discharging device, the humidity detected by the detector may be absolute humidity.

The amount of water contained in the medium wetted by humidity varies with absolute humidity. By controlling the pre-heater based on the absolute temperature detected by the detector, the medium wetted by humidity can be more appropriately dried.

In the liquid discharging device described above, a region that is heated by the pre-heater in the transport direction may be located outside the housing.

The pre-heater heats the medium outside the housing. Thus, the heat of the pre-heater is difficult to reach inside the housing. Thereby, the temperature inside the housing can be suppressed from becoming high.

In the liquid discharging device described above, the control unit may be configured to observe a state variable including the humidity, acquire medium floating data related to the occurrence of medium floating, learn a condition associated with the medium floating of the medium according to a training data that is created based on a combination of the state variable and the medium floating data, and control the pre-heater based on the condition.

According to the above-described configuration, the medium that is wetted by humidity can be appropriately dried.

A control device for the liquid discharging device, can communicate with the liquid discharging unit that includes: a housing, a transporting unit disposed inside the housing and configured to transport a medium placed outside the housing, a discharging unit configured to discharge liquid to the medium transported by the transporting unit, a pre-heater configured to heat the medium upstream of a position at which the liquid is discharged by the discharging unit the a transport direction of the medium, an after-heater configured to heat the medium downstream of the position at which the liquid is discharged by the discharging unit in the transport direction, a detector configured to detect humidity outside the housing, and a control unit configured to control the pre-heater, a control unit configured to control the pre-heater, wherein the control unit is configured to observe a state variable including the humidity detected by the detector, acquire medium floating data related to an occurrence of medium floating, learn a condition associated with medium floating of the medium according to a training data set created based on the combination of the state variable and the medium floating data, and cause the control unit to perform control of the pre-heater based on the condition.

According to the above-described configuration, the medium that is wetted by humidity can be appropriately dried.

What is claimed is:

1. A liquid discharging device, comprising:
a housing;
a transporting unit disposed inside the housing and configured to transport a medium placed outside the housing;
a discharging unit configured to discharge liquid to the medium transported by the transporting unit;
a pre-heater configured to heat the medium upstream, in a transport direction of the medium, from a position at which the liquid is discharged by the discharging unit;
an after-heater configured to heat the medium downstream, in the transport direction, from a position at which the liquid is discharged by the discharging unit;
a detector configured to detect humidity outside the housing; and
a control unit configured to control the pre-heater, wherein
the medium is applied with a tension between a portion that contacts with the transporting unit upstream, in the transport direction, from the position at which the liquid is discharged by the discharging unit, and a portion located downstream from the after-heater in the transport direction, and
the control unit is configured to control the pre-heater based on the humidity detected by the detector.

2. The liquid discharging device according to claim 1, wherein
the control unit sets an output of the pre-heater when the humidity is a second humidity to be greater than an output of the pre-heater when the humidity is a first humidity, wherein the second humidity is higher than the first humidity.

3. The liquid discharging device according to claim 1, wherein
the detector is configured to detect a temperature outside the housing,
the humidity detected by the detector is a relative humidity, and
the control unit is configured to control the pre-heater, based on the relative humidity and the temperature that are detected by the detector.

4. The liquid discharging device according to claim 1, wherein
the humidity detected by the detector is an absolute humidity.

5. The liquid discharging device according to claim 1, wherein
a region, of the medium, heated by the pre-heater in the transport direction is located outside the housing.

6. The liquid discharging device according to claim 1, wherein
the control unit is configured to
observe a state variable including the humidity;
acquire medium floating data related to an occurrence of medium floating;
learn a condition associated with the medium floating of the medium according to a training data set that is created based on the combination of the state variable and the medium floating data; and
control the pre-heater based on the condition.

7. A control device, for the liquid discharging device, configured to communicate with the liquid discharging device, the liquid discharging device including: a housing. a transporting unit disposed inside the housing and configured to transport a medium placed outside the housing, a discharging unit configured to discharge liquid to the medium transported by the transporting unit, a pre-heater configured to heat the medium upstream, in a transport direction of the medium, from a position at which the liquid is discharged by the discharging unit, an after-heater configured to heat the medium downstream, in the transport direction, from a position at which the liquid is discharged by the discharging unit, a detector configured to detect humidity outside the housing, and a control unit configured to control the pre-heater, wherein
the control device is configured to
observe a state variable including the humidity detected by the detector,
acquire medium floating data related to an occurrence of medium floating,
learn a condition associated with medium floating of the medium according to a training data set created based on the combination of the state variable and the medium floating data, and
cause the control unit to perform control of the pre-heater based on the condition.
